(19) United States
(12) Patent Application Publication
(10) Pub. No.: US 2021/0301153 A1
(43) Pub. Date: Sep. 30, 2021

(54) WATERBORNE ANTIFOULING COATING MATERIAL COMPOSITION

(71) Applicant: CHUGOKU MARINE PAINTS, LTD., Otake-shi (JP)

(72) Inventors: Kiwamu YAMANE, Otake-shi (JP); Shotaro HARADA, Otake-shi (JP)

(73) Assignee: CHUGOKU MARINE PAINTS, LTD., Otake-shi (JP)

(21) Appl. No.: 17/202,637

(22) Filed: Mar. 16, 2021

(30) Foreign Application Priority Data
Mar. 26, 2020 (JP) 2020-056680

(51) Int. Cl. C09D 5/16; C08K 3/34; C08K 3/22; C08K 5/36; C09D 7/61; C08L 93/04; C09D 133/08

(52) U.S. Cl. CPC C09D 5/1668; C09D 5/1612; C08K 3/34; C08K 3/22; C08K 5/36; C08K 2003/2248; C09D 7/61; C08L 93/04; C09D 133/08; C08K 2201/016; C08K 2201/019; C09D 5/1687

(57) ABSTRACT

A waterborne antifouling coating material composition according to one embodiment of the present invention includes: synthetic resin (A); at least one component (B) selected from a resin acid and a derivative thereof; flaky pigment (C) having an aspect ratio of 5 to 30; antifouling agent (D); and water (E), wherein a mass ratio (A):(B) between the synthetic resin (A) and the component (B) is 1:0.1 to 1:4.

### BACKGROUND

### Technological Field

One embodiment of the present invention relates to a waterborne antifouling coating material composition, an antifouling coating film, a substrate with an antifouling coating film, or a method for producing a substrate with an antifouling coating film.

### Description of the Related Art

Conventionally, binders for antifouling coating material, including oil resins, vinyl resins, (meth)acrylic resins, and chlorinated rubber resins, have been used mainly; however, all of these have been solvent-diluted types. In recent years, from the viewpoint of environmental conservation and improvement of the coating work environment, it has been desired to make the antifouling coating material water-based (refer to, for example, JP S51-014936 A, JP 2009-173914 A, and JP 2003-277680 A).

### CITATION LIST

### Patent Literature

Patent Literature 1: JP S51-014936 A
Patent Literature 2: JP 2009-173914 A
Patent Literature 3: JP 2003-277680 A

### SUMMARY

Making the antifouling coating material water-based is effective in reducing the amount of volatile organic compounds (VOCs); however, the antifouling coating film formed from the waterborne antifouling coating material has a high affinity with water. Therefore, when such an antifouling coating film is immersed in seawater or fresh water, cracks easily occur, and the coating film finally collapses, making it difficult to exhibit antifouling performance over a long period of time. In order to exhibit sufficient antifouling performance, it is necessary to properly polishing the surface of the coating film and elute an antifouling agent. In addition, when cracks occur in the antifouling coating film, the surface roughness of the coating film increases, and therefore, in a ship having such an antifouling coating film formed on the bottom of the ship, the water flow friction resistance increases, resulting in increase in fuel consumption.

One embodiment of the present invention provides a waterborne antifouling coating material composition capable of forming an antifouling coating film having excellent crack resistance and antifouling performance over a long period of time.

As a result of intensive investigations to solve the above problem, the present inventors have found that the waterborne antifouling coating material composition described below can solve the above problem. That is, one embodiment of the present invention relates to the following [1] to [8].

[1] A waterborne antifouling coating material composition, including: synthetic resin (A); at least one component (B) selected from resin acid and a derivative thereof; flaky pigment (C) having an aspect ratio of 5 to 30; antifouling agent (D); and water (E), wherein a mass ratio between the synthetic resin (A) and the component (B) ((A):(B)) is 1:0.1 to 1:4.
[2] The waterborne antifouling coating material composition according to [1], wherein the synthetic resin (A) is at least one selected from a (meth)acrylic resin, a styrene resin, another vinyl resin, an urethane resin, and a hydrolyzable resin.
[3] The waterborne antifouling coating material composition according to [1] or [2], wherein the flaky pigment (C) is mica having an aspect ratio of 5 to 30.
[4] The waterborne antifouling coating material composition according to any one of [1] to [3], wherein the component (B) is at least one selected from rosin and a derivative thereof.
[5] The waterborne antifouling coating material composition according to any one of [1] to [4], wherein the component (B) is a component other than an alkali metal salt.
[6] An antifouling coating film formed from the waterborne antifouling coating material composition according to any one of [1] to [5].
[7] A substrate with an antifouling coating film, including:
a substrate; and the antifouling coating film according to [6] provided on a surface of the substrate.
[8] A method for producing a substrate with an antifouling coating film, the method including: (1) applying or impregnating to a substrate the waterborne antifouling coating material composition according to any one of [1] to [5] to obtain an applied body or an impregnated body; and (2) drying the applied body or the impregnated body.

### Advantageous Effects of Invention

One embodiment of the present invention can provide a waterborne antifouling coating material composition capable of forming an antifouling coating film having excellent crack resistance and antifouling performance for a long period of time.

### DETAILED DESCRIPTION OF EMBODIMENTS

Hereinafter, one embodiment of the present invention will be described in detail.

Each component described in the present description may be of a single type, or of two or more types.

The term “polymer” means to include homopolymer and copolymer.

The term “(meth)acrylate” is a generic term for acrylate and methacrylate. The same applies to, for example, (meth)acrylic acid.

The term “structural unit derived from XX” means, for example, a structural unit represented by the following formula when XX is represented as A¹A²C=CA³A⁴ (C═C is a polymerizable carbon-carbon double bond, and each of A¹ to A⁴ are atoms or groups bonded to the carbon atom).

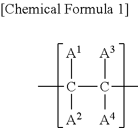

### [Waterborne Antifouling Coating Material Composition]

The waterborne antifouling coating material composition of the present embodiment (hereinafter, also referred to as “composition (I)”) contains synthetic resin (A), at least one component (B) selected from a resin acid and a derivative thereof, flaky pigment (C) having an aspect ratio of 5 to 30, antifouling agent (D), and water (E), each of which are described below.

### <Synthetic Resin (A)>

Examples of synthetic resin (A) include (meth)acrylic resin, styrene resin, other vinyl resin, urethane resin, and hydrolyzable resin. From the viewpoints such as easily forming an antifouling coating film having excellent crack resistance and antifouling performance over a long period of time, (meth)acrylic resin, styrene resin, other vinyl resin, and hydrolyzable resin are preferable, and (meth)acrylic resin, styrene resin, and hydrolyzable resin are more preferable. In addition, from the viewpoints such as allowing easy formation of an antifouling coating film having excellent crack resistance and easy availability as synthetic resin (A), (meth)acrylic resin and styrene resin are preferable.

Examples of the (meth)acrylic resin include a homopolymer or copolymer of at least one monomer selected from (meth)acrylic acid and an ester thereof (hereinafter, also referred to as “(meth)acrylic monomer”), and a copolymer of the (meth)acrylic monomer and a monomer copolymerizable therewith (hereinafter, also referred to as “comonomer”).

Examples of the (meth)acrylic monomer include:

(meth)acrylic acid;

alkylate or cycloalkyl ester of (meth)acrylic acid having 1 to 18 carbon atoms such as methyl (meth)acrylate, ethyl (meth)acrylate, n-propyl (meth)acrylate, isopropyl (meth)acrylate, n-butyl (meth)acrylate, isobutyl (meth)acrylate, t-butyl (meth)acrylate, n-hexyl (meth) acrylate, 2-ethylhexyl (meth) acrylate, n-octyl (meth)acrylate, decyl (meth)acrylate, lauryl (meth)acrylate, stearyl (meth)acrylate, and cyclohexyl (meth)acrylate;

alkoxy alkyl ester of (meth)acrylic acid having 2 to 18 carbon atoms such as methoxybutyl (meth)acrylate, methoxyethyl (meth)acrylate, and ethoxybutyl (meth)acrylate;

dialkylaminoalkyl ester of (meth)acrylic acid such as dimethylaminoethyl (meth)acrylate and dimethylaminopropyl (meth)acrylate; and

glycidyl (meth)acrylate.

One or more of the (meth)acrylic monomer can be used.

Examples of the comonomer include styrene, α-methylstyrene, vinyltoluene, vinyl acetate, vinyl propionate, maleic acid, itaconic acid, (meth)acrylic acid amide, acrylonitrile, and methacrylonitrile.

One or more of the comonomer can be used.

When the (meth)acrylic resin is a copolymer of a (meth)acrylic monomer and a comonomer, the amount of the structural unit derived from the (meth)acrylic monomer is preferably 20% by mass or more, more preferably 40% by mass or more, still more preferably 55% by mass or more, preferably 99.9% by mass or less, and more preferably 99.5% by mass or less; the amount of the structural unit derived from the comonomer is preferably 0.1% by mass or more, more preferably 0.5% by mass or more, preferably 80% by mass or less, more preferably 60% by mass or less, and still more preferably 45% by mass or less, based on the amount of all of the structural unit in the (meth)acrylic resin. The amount of each of the structural unit can be determined by, for example, nuclear magnetic resonance spectroscopy (NMR), pyrolysis gas chromatography mass spectrometry (Pyro-GC/MS).

The (meth)acrylic resin is produced by appropriately selecting a (meth)acrylic monomer and, as necessary, a comonomer in consideration of, for example, the structural unit and weight average molecular weight, and then using a known method, for example, a solution radical polymerization method.

Examples of the styrene resin include a homopolymer of styrene or a copolymer of styrene and a monomer copolymerizable therewith. Examples of the monomer copolymerizable with styrene include the above (meth)acrylic monomer, α-methylstyrene, vinyltoluene, vinyl acetate, vinyl propionate, maleic acid, itaconic acid, (meth)acrylic acid amide, acrylonitrile, methacrylonitrile, and butadiene. The copolymer of a (meth)acrylic monomer and styrene is classified as styrene resin when the amount of the structural unit derived from styrene is larger than the amount of the structural unit derived from the (meth)acrylic monomer, and is classified as a (meth)acrylic resin when the amount of the structural unit derived from the (meth)acrylic monomer is equal to or larger than the amount of the structural unit derived from styrene, based on the amount of all of the structural unit in the resin (based on % by mass). The same applies to other resins.

Examples of other vinyl resins include a homopolymer or copolymer of a vinyl compound such as vinyl chloride, vinyl acetate, and vinyl propionate, and a copolymer of the vinyl compound and a monomer copolymerizable therewith. Examples of the above copolymer include: vinyl chloride copolymers such as vinyl chloride/vinyl acetate copolymer, vinyl chloride/vinyl acetate/vinyl alcohol copolymer, vinyl chloride/vinyl isobutyl ether copolymer, vinyl chloride/vinyl propionate copolymer; and ethylene/vinyl acetate copolymer.

The urethane resin may be a reaction product of a polyol and an isocyanate compound. Examples of the polyol include polyhydric alcohol, polyether polyol, polyester polyol, polyether ester polyol, (meth)acrylic polyol, polycarbonate polyol, and polyolefin polyol. In addition, examples of the isocyanate compound include aliphatic, alicyclic, and aromatic polyisocyanates.

(Meth)acrylic resins, styrene resins, other vinyl resins, and urethane resins are typically insoluble resins that do not hydrate or undergo chemical reactions in seawater or fresh water (resins other than hydrolyzable resins).

Whereas, the hydrolyzable resin is typically a resin that promotes hydrolysis of the resin, and dissolves in seawater or fresh water to exhibit the self-polishing property of a coating film. Examples of the hydrolyzable resin include silyl ester polymers and zinc (meth)acrylic resins.

The silyl ester polymer is preferably, for example, a silyl ester polymer having structural unit (a-1) derived from polymerizable monomer (a1) represented by Formula (a1).

Structural unit (a-1) included in the silyl ester polymer may be of a single type, or of two or more types.

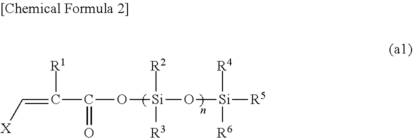

Each of symbol in Formula (a1) will be described below.

R¹ is a hydrogen atom or a methyl group, preferably a methyl group.

R² to R⁶ are each independently monovalent organic groups that have 1 to 20 carbon atoms and may have one or more heteroatoms. Examples of the above organic group include a linear or branched alkyl group, a cycloalkyl group, and an aryl group in which a heteroatom such as an oxygen atom may intervene between carbon atoms, and from the viewpoints such as allowing easy formation of the coating film having excellent antifouling properties, a linear or branched alkyl group having 1 to 8 carbon atoms is preferable, and a branched alkyl group is more preferable.

Examples of the linear or branched alkyl group include a methyl group, an ethyl group, a propyl group, an isopropyl group, a butyl group, an isobutyl group, a sec-butyl group, a t-butyl group, a pentyl group, a hexyl group, and a 2-ethylhexyl group, and the isopropyl group is preferable.

n is an integer of 0 or 1 or more, preferably 0. The upper limit of n may be, for example, 50.

X is a hydrogen atom or a group represented by R⁷—O—C(═O)—, preferably a hydrogen atom. R⁷ is a hydrogen atom, a monovalent organic group that has 1 to 20 carbon atoms and may have one or more heteroatoms, or a silyl group represented by R⁸R⁹R¹⁰Si—. R⁸, R⁹, and R¹⁰ are each independently monovalent organic groups that have 1 to 20 carbon atoms and may have one or more heteroatoms. Examples of the monovalent organic group that has 1 to 20 carbon atoms and may have one or more heteroatoms include the above specific examples.

The polymerizable monomer (a1) is preferably trialkylsilyl (meth) acrylate, alkyldiarylsilyl (meth)acrylate, and aryldialkylsilyl (meth)acrylate, and more preferably trialkylsilyl (meth)acrylate. Examples of the trialkylsilyl (meth)acrylate include trimethylsilyl (meth)acrylate, triethylsilyl (meth)acrylate, tripropylsilyl (meth)acrylate, triisopropylsilyl (meth)acrylate, tributylsilyl (meth) acrylate, triisobutylsilyl (meth) acrylate, tri-sec-butylsilyl (meth) acrylate, tri-2-ethylhexylsilyl (meth)acrylate, and butyldiisopropylsilyl (meth)acrylate. In addition, examples of polymerizable monomer (a1) include a polymerizable monomer having n of 2 or more in Formula (a1) such as 1-(meth)acryloyloxynonamethyltetrasiloxane. Of these, from the viewpoints such as allowing easy formation of an antifouling coating film having crack resistance and antifouling property in an excellent balance, a trialkylsilyl (meth)acrylate having a branched alkyl group is preferable, a triisopropylsilyl (meth)acrylate is more preferable, and triisopropylsilyl methacrylate is particularly preferable.

The silyl ester polymer can further have structural unit (a-2) derived from another ethylenically unsaturated monomer (hereinafter, also referred to as “monomer (a2)”).

Examples of the monomer (a2) include the above (meth)acrylate monomer, styrene, α-methylstyrene, vinyltoluene, vinyl acetate, vinyl propionate, maleic acid, itaconic acid, (meth)acrylic acid amide, acrylonitrile, methacylonitrile, and aliphatic carboxylate metal (meth)acrylate.

Structural unit (a-2) included in the silyl ester polymer may be one or may be two or more.

The ratio of structural unit (a-1) in the silyl ester polymer is preferably 30% by mass or more, more preferably 40% by mass or more, still more preferably 45% by mass or more, preferably 80% by mass or less, more preferably 75% by mass or less, and still more preferably 70% by mass or less.

The ratio of the structural unit (a-2) in the silyl ester polymer is preferably 20% by mass or more, more preferably 25% by mass or more, still more preferably 30% by mass or more, preferably 70% by mass or less, more preferably 60% by mass or less, and still more preferably 55% by mass or less.

Zinc (meth)acrylic resin is represented by Formula (a21) or Formula (a22). The zinc (meth)acrylic resin is a salt formed by zinc and an organic, and is a resin having a structure formed by combining zinc and carboxylic acid.

R^{a}—COO—Zn—OOC—R² Formula (a21):

R^{a}—COO—Zn—OOC—R^{b} Formula (a22):

In Formula (a21) and Formula (a22), R^{a} each independently represents a base resin and R^{b} each independently represents a monovalent organic group having 1 to 20 carbon atoms. In addition, instead of Zn, those including polyvalent metals such as Cu, Ca, Mg, Fe, and Ni may be used in combination.

Base resin R^{a}, which is the base of the zinc (meth)acrylic resin, is a resin having an acid value of typically about 1 to 300 mgKOH/g. In order to produce the zinc (meth)acrylic resin represented by Formula (a21) and Formula (a22) by using such a base resin, for example, a divalent metal (Zn) oxide or hydroxide may be reacted in an amount of about 0.1 to 1 mol with 1 mol of a resin having a carboxy group in the molecule in the presence of a small amount of water.

Examples of the resin having a carboxy group in the molecule include polyester, polyurethane, natural resin, and vinyl resin, and the vinyl resin is preferable. The vinyl resin is, for example, a (meth)acrylic resin, preferably the resin having a structural unit derived from (meth)acrylic acid, preferably has a weight average molecular weight of 1,000 or more, more preferably 2,000 or more, still more preferably 3,000 or more, preferably 300,000 or less, more preferably 250,000 or less, still more preferably 200,000 or less, and has the above acid value. Examples of the (meth)acrylic resin include the above examples.

Specific examples of the zinc (meth)acrylic resin and the production method thereof include the specific examples and the production method described in JP H08-209005 A and JP H05-171066 A.

From the viewpoint of obtaining an antifouling coating material composition having excellent film-forming property, the weight average molecular weight (Mw) of synthetic resin (A) is preferably 1,000 or more, more preferably 2,000 or more, preferably 1,000,000 or less, and more preferably 700,000 or less. Mw can be measured by gel permeation chromatography (GPC). When the aqueous dispersion of synthetic resin (A) is a so-called self-crosslinking resin that becomes high molecular weight in evaporating a solvent, the upper limit of the above Mw is not limited.

From the viewpoints such as easy formation of an antifouling coating film having crack resistance and antifouling property in a good balance, the glass transition temperature (Tg) of synthetic resin (A) is preferably −50° C. or more, preferably 90° C. or less, more preferably 60° C. or less, and still more preferably 40° C. or less. Tg can be measured by a differential scanning calorimetry (DSC).

One or more of synthetic resin (A) can be used.

The content of synthetic resin (A) is preferably 3% by mass or more, more preferably 5% by mass or more, preferably 45% by mass or less, and more preferably 40% by mass or less, with respect to 100% by mass of the solid content of the composition (I). Such an aspect tends to allow formation of an antifouling coating film having an appropriate polishing property of the surface of the coating film.

The solid content of the composition (I) and each component (for example, aqueous dispersion) means the heating residue after drying in an incubator at 108° C. for 3 hours.

In the production of the composition (I), an aqueous dispersion of synthetic resin (A), particularly an aqueous emulsion is preferably used, from the viewpoint of the physical properties of an antifouling coating film obtained. From the viewpoint of the stability of the dispersion, the solid content of synthetic resin (A) in the aqueous dispersion is preferably 30% by mass or more, more preferably 40% by mass or more, preferably 70% by mass or less, and more preferably 60% by mass or less.

The aqueous dispersion of synthetic resin (A) is a dispersion in which synthetic resin (A) is dispersed in a dispersion medium including water (hereinafter, also referred to as “aqueous medium”). The aqueous medium is not particularly limited as long as it includes water; however, the content of water in the aqueous medium is preferably 50 to 100% by mass, and more preferably 60 to 100% by mass.

The aqueous medium may include a medium other than water, and examples of such a medium include acetone, methyl alcohol, ethyl alcohol, n-propyl alcohol, isopropyl alcohol, n-butyl alcohol, isobutyl alcohol, 2-methoxyethanol, 2-ethoxyethanol, 2-butoxyethanol, 1-methoxy-2-propanol, 1-ethoxy-2-propanol, diacetone alcohol, dioxane, ethylene glycol, ethylene glycol dimethyl ether, ethylene glycol diethyl ether, ethylene glycol monopropyl ether, and ethylene glycol monohexyl ether. One or more of these can be used.

An aqueous emulsion of synthetic resin (A) can be prepared by emulsifying synthetic resin (A) with a surfactant to form an emulsion. In addition, an emulsion can be directly prepared by emulsion polymerization of the monomer forming synthetic resin (A). The surfactant is not particularly limited, and can be appropriately selected from a cationic surfactant, an anionic surfactant, and a nonionic surfactant.

### <Component (B)>

Component (B) is at least one selected from the resin acid and derivatives thereof. The component (B) contributes to, for example, the adjustment of the polishing rate of an antifouling coating film obtained and the improvement of long-term antifouling property.

Examples of derivatives of the resin acid include hydrogenated bodies, disproportionated bodies, and metal salts of the resin acid. Examples of the metal salt include alkali metal salts such as sodium salt and potassium salt, zinc salt, copper salt, aluminum salt, magnesium salt, calcium salt, and barium salt.

Examples of the component (B) include rosins such as gum rosin, wood rosin, and tall oil rosin; rosin derivatives such as hydrogenated rosin, disproportionated rosin, and rosin metal salt; and copal resin and derivatives thereof. In addition, a rosin resin acid that is a component included in rosin, a copal resin acid that is a component included in copal resin, and derivatives thereof may be used as component (B). Examples of the rosin resin acid and their derivatives include abietic acid, neoavietic acid, dehydroabietic acid, secodehydroabietic acid, dihydroabietic acid, tetrahydroabietic acid, pimaric acid, isopimaric acid, levopimaric acid, paramatrinic acid, and sandara-copimaric acid. Examples of the copal resin acid and derivatives thereof include agathene dicarboxylic acid and agathene dicarboxylic acid monoalkyl ester. At least one selected from rosin and a derivative thereof (rosin derivative) is preferable as component (B).

In order to develop antifouling performance, it is effective to add at least one component (B) selected from the resin acid and a derivative thereof, and particularly of components (B), selecting components other than alkali metal salts can exhibit more excellent antifouling performance. When synthetic resin (A) is a hydrolyzable resin, of components (B), a metal salt other than the alkali metal salt is preferable.

One or more of components (B) can be used.

The content of component (B) is preferably 1% by mass or more, more preferably 2% by mass or more, preferably 30% by mass or less, and more preferably 20% by mass or less, with respect to 100% by mass of the solid content of the composition (I). Such an aspect tends to allow easy formation of a coating film having excellent antifouling property.

In composition (I), the mass ratio between synthetic resin (A) to component (B) ((A):(B)) is 1:0.1 to 1:4, preferably 1:0.4 to 1:3.8, and more preferably 1:0.8 to 1:3.5. Composition (I) including synthetic resin (A) and component (B) in the mass ratio described above and including flaky pigment (C) having an aspect ratio in the range described later can form an antifouling coating film that is particularly excellent in crack resistance and long-term antifouling property (particularly long-term dynamic antifouling property). In the evaluation of antifouling property, in the case of the static antifouling property test, cracks occur in the coating film, peeling does not easily occur, and the antifouling property may not deteriorate; however, in the case of the dynamic antifouling property test, cracks occur in the coating film, peeling easily occurs, and the antifouling property tends to be significantly deteriorated. The dynamic antifouling property test is, for example, a test method in which a test plate with an antifouling coating film is provided on the side of a rotating rotor, the rotor is immersed in the sea, and the test plate is rotated at a speed of about 15 knots.

In the production of the composition (I), an aqueous dispersion of component (B), particularly an aqueous emulsion is preferably used. The content of the solid content of component (B) in the aqueous dispersion is preferably 20% by mass or more, more preferably 35% by mass or more, preferably 80% by mass or less, and more preferably 65% by mass or less, from the viewpoint of workability in the production of coating material composition.

The aqueous dispersion of the component (B) is a dispersion in which component (B) is dispersed in an aqueous medium. The aqueous medium is not particularly limited as long as it includes water; however, the content of water in the aqueous medium is preferably 50 to 100% by mass, and more preferably 60 to 100% by mass. Specific examples of media other than water in the aqueous medium are as described above.

### <Flaky Pigment (C)>

Flaky pigment (C) is a pigment having an aspect ratio of 5 to 30. The aspect ratio of flaky pigment (C) is preferably 7 or more, more preferably 10 or more, preferably 27 or less, and more preferably 25 or less. Using flaky pigment (C) having an aspect ratio in this range improves the crack resistance of the antifouling coating film that has been immersed in seawater or fresh water, and thereby peeling of the coating film hardly occurs and stable antifouling performance can be exhibited for a long period of time. It is assumed that flaky pigment (C) in the coating film prevents the infiltration of water and relaxes the internal stress of the coating film to improve the crack resistance.

The aspect ratio of flaky pigment (C) can be calculated by measuring the thickness of flaky pigment (C) and the maximum length on the main surface thereof for any 100 pieces and by determining the average value of these ratios (maximum length on the main surface/thickness) with using a scanning electron microscope (SEM), for example, “TM 3030 Plus Miniscope” (manufactured by Hitachi High-Technologies Corporation, desktop SEM).

The thickness of flaky pigment (C) can be measured by observing the horizontal direction of the main surface (the surface having the largest area) of the pigment, and the maximum length on the main surface of flaky pigment (C) means, for example, the length of the diagonal line when the main surface is square, the diameter when the main surface is circular, and the length of the major axis when the main surface is elliptical.

The median diameter (d50) of flaky pigment (C) is preferably 1 μm or more, more preferably 10 μm or more, preferably 100 μm or less, and more preferably 60 μm or less. The median diameter can be measured by using a laser scattering diffraction type particle size distribution measuring device, for example, “SALD 2200” (manufactured by Shimadzu Corporation).

Flaky pigment (C) is not particularly limited, examples thereof include inorganic pigments having a plate-shaped structure having the above aspect ratio, specific examples thereof include mica, glass flakes, and aluminum flakes, and the mica is particularly preferable.

One or more of flaky pigment (C) can be used. For example, a flaky pigment having an aspect ratio of 5 to 30 measured in advance may be blended in producing composition (I).

From the viewpoint of improving crack resistance, the content of flaky pigment (C) is preferably 1% by mass or more, more preferably 2% by mass or more, more preferably 3% by mass or more, preferably 30% by mass or less, more preferably 25% by mass or less, and still more preferably 20% by mass or less, in 100% by mass of the solid content of composition (I).

### <Antifouling Agent (D)>

Antifouling agent (D) may be any of organic and inorganic antifouling agents.

Examples of the inorganic antifouling agent include copper or copper compounds (excluding pyrithione compounds) such as cuprous oxide, metallic copper powder, and copper thiocyanate (copper rhodanide), and the cuprous oxide and copper thiocyanate (copper rhodanide) are preferable.

Examples of the organic antifouling agent include:

metal pyrithione (pyrithione compounds) such as copper pyrithione and zinc pyrithione;

tetraalkylthiuramdisulfide such as tetramethylthiuramdisulfide;

carbamate compounds such as zinc dimethyl dithio carbamate, zinc ethylene bisdithiocarbamate, and bisdimethyldithiocarbamoyl zinc ethylene bisdithiocarbamate;

maleimide compounds such as 2,4,6-triphenylmaleimide, 2,3-dichloro-N-(2′,6′-diethylphenyl)maleimide, and 2,3-dichloro-N-(2′-ethyl-6′-methylphenyl)maleimide;

2,4,5,6-tetrachloroisophthalonitrile, N,N-dimethyldichlorophenylurea, 4,5-dichloro-2-n-octyl-4-isothiazolin-3-one, 2-methylthio-4-tert-butylamino-6-cyclopropyl-S-triazine, chloromethyl-n-octyl disulfide, N′,N′-dimethyl-N-phenyl-(N-fluorodichloromethylthio)sulfamide, N′,N′-dimethyl-N-tolyl-(N-fluorodichloromethylthio)sulfamide;

amine-organic borane complexes such as pyridinetriphenylborane and 4-isopropylpyridinediphenylmethylborane; and

(+/−)-4-[1-(2,3-dimethylphenyl)ethyl]-1H-imidazole (medetomidine).

Of these organic antifouling agents, copper pyrithione, zinc pyrithione, zinc ethylenebisdithiocarbamate, 2-methylthio-4-tert-butylamino-6-cyclopropyl-S-triazine, and (+/−)-4-[1-(2,3-dimethylphenyl)ethyl]-1H-imidazole (medetomidine) are preferable, and copper pyrithione, zinc ethylenebisdithiocarbamate, and (+/−)-4-[1-(2,3-dimethylphenyl)ethyl]-1H-imidazole (medetomidine) are more preferable.

One or more of antifouling agents (D) can be used.

The content of antifouling agent (D) is preferably 0.01% by mass or more, more preferably 0.05% by mass or more, preferably 80% by mass or less, and more preferably 75% by mass or less, in 100% by mass of the solid content of composition (I).

### <Water (E)>

Composition (I) is a waterborne antifouling coating material composition. The “waterborne composition” refers to a composition including water. The content of water in composition (I) is preferably 5% by mass or more, more preferably 10% by mass or more, preferably 50% by mass or less, and more preferably 45% by mass or less.

### <Other Components>

As necessary, composition (I) may contain additives such as pigments other than flaky pigment (C) having an aspect ratio in the above range (for example, extender pigments and coloring pigments), pigment dispersing agent, antifoaming agent, thickening agent, antisettling agent, and film-forming agent, as long as the effect of the present invention is not impaired. One or more of the additives can be used.

Examples of extender pigments include zinc oxide, talc, silica, mica, clay, potash feldspar, calcium carbonate, kaolin, alumina white, white carbon, aluminum hydroxide, magnesium carbonate, barium carbonate, barium sulfate, and zinc sulfide. The content of the extender pigment is preferably 0.1% by mass or more, more preferably 1% by mass or more, preferably 90% by mass or less, and more preferably 75% by mass, in 100% by mass of the solid content of composition (I).

Various conventionally known organic and inorganic pigments can be used as the coloring pigment. Examples of the organic pigment include naphthol red and phthalocyanine blue. Examples of the inorganic pigment include carbon black, red iron oxide, titanium white (titanium oxide) and yellow iron oxide. The content of the coloring pigment is preferably 0.01 to 50% by mass, and more preferably 0.01 to 30% by mass, in 100% by mass of the solid content of composition (I).

The pigment dispersing agent is preferably a dispersing agent capable of uniformly dispersing the pigment in the coating material composition to prepare a stable dispersion. Examples of the pigment dispersing agent include a polymer dispersing agent. The content of the pigment dispersing agent is preferably 0.01 to 5% by mass in 100% by mass of the solid content of composition (I).

The antifoaming agent is preferably a material capable of suppressing the generation of foam during the production and/or coating application of the coating material composition, or a material capable of breaking the foam generated in the coating material composition. Examples of the antifoaming agent include silicone antifoaming agents and mineral oil antifoaming agents. The content of the antifoaming agent is preferably 0.01 to 2% by mass in 100% by mass of the solid content of composition (I).

For example, a commercially available product that is generally marketed as a thickening agent can be used as the thickening agent. The commercially available product is not particularly limited, and examples thereof include an alkali thickening agent, a nonionic association thickening agent, a water-soluble polymer thickening agent, and a polyamide thickening agent. The content of the thickening agent is preferably 0.01 to 10% by mass in 100% by mass of the solid content of composition (I).

The antisettling agent is preferably a material capable of suppressing pigment settling in the coating material composition and improving the storage stability thereof. Examples of the antisettling agent include organic thixotropic agents such as hydrogenated castor oil thixotropic agents and polyethylene oxide thixotropic agents; and inorganic thixotropic agents such as clay minerals (for example, bentonite, smectite, and hectorite) and synthetic fine silica. The content of the antisettling agent is preferably 0.01 to 5% by mass in 100% by mass of the solid content of composition (I).

Examples of the film-forming agent include conventionally known alcohols, glycol ethers, and esters, and examples thereof include alcohols such as alcohol having 1 to 3 carbon atoms such as isopropyl alcohol, and 2,2,4-trimethylpentanediol; glycol ethers such as ethylene glycol monobutyl ether, ethylene glycol diethyl ether, diethylene glycol monobutyl ether, diethylene glycol diethyl ether, propylene glycol diethyl ether, dipropylene glycol diethyl ether, and dipropylene glycol n-butyl ether; and esters such as 2,2,4-trimethyl-1,3-pentanediol monoisobutyrate. The content of the film-forming agent is preferably 0.1 to 15% by mass, and more preferably 0.1 to 5% by mass, in 100% by mass of the total amount of composition (I).

### <Method for Producing Waterborne Antifouling Coating Material Composition>

Composition (I) can be produced by appropriately using a known method. For example, the production can be performed by adding synthetic resin (A), component (B), flaky pigment (C), antifouling agent (D), and the above other components as necessary to a mixing container at once or in any order, mixing each component by a known stirring/mixing means, and by dispersing or dissolving in water (E).

In the production of composition (I), the aqueous dispersion of synthetic resin (A) and the aqueous dispersion of component (B) are preferably used, from the viewpoint of workability in the production of the coating material composition.

Examples of the stirring/mixing means include means using a paint shaker, a high-speed disperser, a sand grind mill, a basket mill, a ball mill, a triple roll mill, a ross mixer, or a planetary mixer.

Composition (I) can form a coating film having excellent crack resistance and preventing the adhesion of aquatic organisms on the surface of a substrate such as a ship for a long period of time. The improvement of crack resistance suppresses an increase in surface roughness and an increase in water flow resistance due to the occurrence of cracks, and also contributes to a reduction in fuel consumption in the case of a ship, for example. In addition, composition (I) is also suitable for repair coating application because cracks and peeling of the coating film hardly occur when composition (I) is repeatedly applied. Composition (I) is a waterborne coating material and therefore has extremely little adverse effect on the environment and the human body, and is also excellent in storage stability.

Composition (I) is preferably a low VOC coating material composition.

“Low VOC” means that the composition contains almost no volatile organic compound (VOC) components such as organic solvents, and specifically, the VOC content in the composition when adjusted to a viscosity suitable for coating application is 200 g/L or less. The VOC content in composition (I) is preferably 180 g/L or less, and more preferably 160 g/L or less.

The VOC content in the composition can be calculated from the following Formula (1) by using the following values of composition specific gravity and the heating residue.

VOC content (g/L)=composition specific gravity×1000×(100−heating residue−moisture content)/100 (1)

Composition specific gravity (g/mL): a value calculated by filling a specific gravity cup having an internal volume of 100 mL with the composition under a temperature condition of 23° C. and by weighing the composition.

Heating residue (% by mass): a mass percentage value calculated by weighing 1 g of the composition on a flat bottom dish, spreading evenly with a wire of known mass, drying at 108° C. for 3 hours, and then weighing the mass of the residue and the wire.

Moisture content (% by mass): percent by mass of water included in 100% by mass of the composition, which is measured by using, for example, a water content measuring device, CA-310, manufactured by Mitsubishi Chemical Analytech Co., Ltd.

### [Use of Waterborne Antifouling Coating Material Composition]

The antifouling coating film of the present embodiment (hereinafter, also referred to as “antifouling coat (J)”) is formed from composition (I). The substrate with the antifouling coating film (hereinafter, also referred to as “antifouling substrate (K)”) of the present embodiment has a substrate and antifouling coat (J) provided on the surface of the substrate.

The method for producing antifouling substrate (K) has a step (1) of applying or impregnating composition (I) to the substrate (object or object to be coated) to obtain an applied body or an impregnated body, and a step (2) of drying the applied body or the impregnated body.

For example, a known method such as an air spray, an airless spray, a brush coating application, and a roller coating application can be used for applying.

Composition (I) applied or impregnated by the above method is dried by being left to stand, for example, under the condition of −5 to 30° C. for preferably about 1 to 10 days, more preferably about 1 to 7 days, and antifouling coat (J) can be thus obtained. Composition (I) may be dried while blowing air under heating.

Alternatively, antifouling substrate (K) can be produced by forming antifouling coat (J) from composition (I) on the surface of the temporary substrate, peeling off this antifouling coat (J) from the temporary substrate, and by attaching to a substrate to be antifouled. At this time, antifouling coat (J) may be attached onto the substrate via an adhesive layer.

The surface of the substrate may be primer-treated, and may have a layer formed from various resin coating materials such as epoxy resin coating materials, vinyl resin coating materials, acrylic resin coating materials, and urethane resin coating materials. In this case, the surface of the substrate on which antifouling coat (J) is provided means the surface after the primer treatment or the surface of the layer formed from the above resin coating material.

The substrate is not particularly limited, but composition (I) is preferably used for long-term antifouling of the substrate in a wide range of industrial fields such as ships, fisheries, and underwater structures. Therefore, examples of the substrate include: ships (for example, large steel ships such as container ships and tankers, fishing ships, FRP ships, wooden ships, outer plates of ship such as yachts, any of these new building or repaired ships); underwater structures (for example, oil pipelines, water pipes, circulating water pipes, water supply and drainage ports of factories and thermal and nuclear power plants, submarine cables, seawater utilization equipment (for example, seawater pumps), mega floats, coast roads, submarine tunnels, harbors equipment, various underwater civil engineering structures in canals or waterways); fishery materials (for example, ropes, fishing nets, fishing gear, floats, buoys); water supply and drainage pipes for seawater in factories, and thermal and power plants; diver suits; underwater glasses; oxygen cylinders; swimwear; and torpedoes. Of these, ships, underwater structures, fishery materials, and water supply and drainage pipes are preferable, ships and underwater structures are more preferable, and ships are particularly preferable.

In producing antifouling substrate (K), when the substrate is a fishing net or a steel plate, composition (I) may be directly applied to the surface of the substrate. When the substrate is a fishing net, the surface thereof may be impregnated with composition (I). When the substrate is a steel plate, an undercoating material such as a rust inhibitor and/or a primer is applied to the surface of the substrate in advance to form a base layer, and then composition (I) may be applied to the surface of the base layer. In addition, for the purpose of repair, antifouling coat (J) may be further formed on the surface of the substrate on which antifouling coat (J) or the conventional antifouling coating film is formed, such as a steel plate having a deteriorated antifouling coating film.

The thickness of antifouling coat (J) is not particularly limited, but is, for example, about 30 to 1000 μm. When forming antifouling coat (J), there is a method in which the thickness of the antifouling coating film formed by once coating application is preferably 10 to 300 μm, more preferably 30 to 200 μm, and the number of applying times is once to multiple.

The ship having antifouling coat (J) can prevent the adhesion of aquatic organisms and therefore prevent a decrease in ship speed and an increase in fuel consumption. The underwater structure having antifouling coat (J) can prevent the adhesion of aquatic organisms for a long period of time and therefore maintain the function of the underwater structure for a long period of time. The fishing net having antifouling coat (J) has less risk of environmental pollution, and can prevent the adhesion of aquatic organisms and therefore prevent blockade of the net. In addition, the water supply and drainage pipe having antifouling coat (J) on the inner surface can prevent the adhesion and reproduction of aquatic organisms and therefore can prevent blockade of the water supply and drainage pipe and thus prevent a decrease in the flow velocity.

### EXAMPLE

Hereinafter, the present invention will be described in more detail based on examples and comparative examples, but the present invention is not limited to the following examples. In the following examples and comparative examples, “parts” indicates “parts by mass”.

### <Glass Transition Temperature (Tg) of Synthetic Resin>

Synthetic resin (A) was dried at 108° C. for 3 hours, and then the change in calorific value in the range of −50° C. to 150° C. was measured by using a differential scanning calorimeter (for example, DSC Q2000, manufactured by TA Instruments, Inc.) at a heating rate of 20° C./min under a nitrogen atmosphere. The glass transition temperature (Tg) was defined as the temperature (° C.) at the onset value of DSC during heating.

### <Aspect Ratio of Pigment>

The aspect ratio of the pigment was calculated by using a scanning electron microscope (SEM) “TM 3030 Plus Miniscope” (manufactured by Hitachi High-Technologies Corporation, desktop SEM) to measure the thickness and the maximum length on the main surface for any 100 pieces of the pigment and to determine the average value of these ratios (maximum length on the main surface/thickness).

The thickness of the pigment was measured by observing the horizontal direction of the main surface (the surface having the largest area) of the pigment, and the maximum length on the main surface of the pigment means the length of the diagonal line when the main surface is square, the diameter when the main surface is circular, and the length of the major axis when the main surface is elliptical.

### <Solid Content>

The solid content of the composition and each component mean the heating residue when dried in an incubator at 108° C. for 3 hours. From this heating residue, the solid content (% by mass) of the composition and each component was calculated.

### Production Example 1

53 parts of xylene were charged into a reaction vessel equipped with a stirrer, a reflux condenser, a thermometer, a nitrogen introduction tube, and a dropping funnel, and was heated under normal pressure until the temperature of xylene reached 85° C. while xylene was stirred in a nitrogen atmosphere with a stirrer. A monomer mixture consisting of 60 parts of triisopropylsilylmethacrylate (TIPSMA), 20 parts of 2-methoxyethyl methacrylate (MEMA), 10 parts of methyl methacrylate (MMA), 10 parts of butyl acrylate (BA), and a part of 2,2′-azobis (2-methylbutyronitrile) (AMBN) was added dropwise into the reaction vessel over 2 hours by using a dropping funnel while maintaining the temperature of xylene in the reaction vessel at 85° C.

Then, 0.5 parts of t-butyl peroxyoctoate was further added to the reaction vessel, the mixture was stirred with a stirrer for 2 hours under normal pressure while maintaining the liquid temperature in the reaction vessel at 85° C., the liquid temperature in the vessel was raised from 85° C. to 110° C. and heated for 1 hour, 14 parts of xylene was added into the reaction vessel to lower the liquid temperature in the reaction vessel, stirring was stopped at the liquid temperature of 40° C., and thus a hydrolyzable polymer solution including a hydrolyzable copolymer was prepared.

200 parts of the hydrolyzable polymer solution that had been heated to 30° C. and held were charged into a 500 ml plastic container, 14 parts of the heat-melted emulsifier (polyoxyethylene lauryl ether) was added thereto while stirring with a disperser, and dissolved and mixed uniformly.

Then, while stirring the obtained solution with a disperser, 60 parts of ion-exchanged water was added dropwise into the solution from the dropping funnel over 30 minutes and mixed uniformly. Moreover, while stirring the obtained solution with a disperser, 120 parts of ion-exchanged water was added dropwise into the solution from the dropping funnel over 1 hour, uniformly mixed, and subjected to phase inversion emulsification to provide emulsion 1 having a solid content of 45%.

### Production Example 2

120 parts of xylene and 161 parts of WW rosin were charged into a reaction vessel equipped with a stirrer, condenser, thermometer, dropping device, nitrogen introduction tube, heating and cooling jacket, heated from room temperature to 50° C. while stirring with a stirrer under a nitrogen stream, and thereby the WW rosin was dissolved. Thereafter, 24 parts of zinc oxide was added thereto, the temperature was raised from 50° C. to 85° C. while stirring with a stirrer under a nitrogen stream, and the mixture was stirred at a liquid temperature of 85° C. for 9 hours. The solution was confirmed to become transparent, and then the solution was azeotropically dehydrated with xylene as a solvent in order to remove the produced water. Then, the liquid temperature was raised from 85° C. to 150° C., the liquid temperature was maintained at 150° C., the solution was confirmed to be transparent without water distilled at this temperature, and then the reaction was finished to provide a transparent rosin zinc salt-containing compound.

225 parts of the rosin zinc salt-containing compound that had been heated to 30° C. and held were charged into a 500 ml plastic container, 27 parts of the heat-melted emulsifier (polyoxyethylene lauryl ether) was added thereto while stirring with a disperser, and dissolved and mixed uniformly.

Then, while stirring the obtained solution with a disperser, 45 parts of ion-exchanged water was added dropwise into the solution from the dropping funnel over 30 minutes and mixed uniformly. Moreover, while stirring the obtained solution with a disperser, 90 parts of ion-exchanged water was added dropwise into the solution from the dropping funnel over 1 hour, uniformly mixed, and subjected to phase inversion emulsification to provide emulsion 2 having a solid content of 50%.

### Preparation of Antifouling Coating Material Composition

### Example 1

The antifouling coating material composition was prepared as follows.

11.6 parts of ion-exchanged water, 1.5 parts of Disperbyk-190 (dispersing agent, manufactured by BYK-Chemie Japan Co., Ltd.), and 0.2 parts of Benton DE (antisettling agent, manufactured by Elementis specialties Inc.) were added into a plastic container, and each component was uniformly dispersed or dissolved by mixing with a paint shaker. Thereafter, into the plastic container, 3 parts of Mica Powder 325 mesh (flaky pigment, manufactured by Fukuoka Talc Co., Ltd.), 30 parts of cuprous oxide NC-301 (antifouling agent, manufactured by NC Tech Co., Ltd.), 4 parts of Zineb TC (antifouling agent, manufactured by Cerexagri S.A.), 3.8 parts of TTK Talc (extender pigment, manufactured by Takehara Chemical Industry Co., Ltd.), 0.6 parts of Noveperm Red F5RK (coloring pigment, manufactured by Clariant Japan K.K.), 0.3 parts of BYK-018 (antifoaming agent, manufactured by BYK-Chemie Japan Co., Ltd.), and 150 parts of glass beads were added and stirred by using a paint shaker for 1 hour to disperse these components.

After dispersion, glass beads were removed from the mixture through a filtration net (opening: 80 mesh) to obtain a filtrate, and into the filtrate, 28 parts of New Coat TS-100 (synthetic resin, manufactured by Shin-Nakamura Chemical Co., Ltd.), 14 parts of Harsize NES-500 (resin acid, manufactured by Harima Chemicals, Inc.), 0.5 parts of Adekanol UH-752 (thickening agent, manufactured by ADEKA Corporation), 2 parts of Kyowanol M (film-forming agent, manufactured by KH Neochem Co., Ltd.), and 0.5 parts of Butyl Cellosolve (film-forming agent, manufactured by KH Neochem Co., Ltd.) were added, and dispersed by using a disperser for 20 minutes to provide an antifouling coating material composition.

### Examples 2 to 16 and Comparative Examples 1 to 6

An antifouling coating material composition was prepared in the same manner as in Example 1 except that the type and blending amount of each component were changed as shown in Table 1 and Table 3.

### [Evaluation of Physical Properties of Antifouling Coating Material Composition]

The physical properties of the coating film formed by using the antifouling coating material compositions obtained in Examples and Comparative Examples were evaluated as follows. The results obtained are shown in Table 1 to Table 3.

### <Static Antifouling Property Test>

Epoxy anticorrosion coating material (trade name “Banno 500”, manufactured by Chugoku Marine Paints Ltd.) was applied onto a sandblasted steel plate (300 mm×100 mm×2.3 mm) by using an applicator, so that the dry film thickness was 150 μm, and dried to form a cured coating film. Then, onto the cured coating film, epoxy binder coating material (trade name “Banno 500N”, manufactured by Chugoku Marine Paints Ltd.) was applied so that the dry film thickness was 100 μm, and dried at 23° C. for 1 day to produce a test plate.

Then, onto the test plate (on the surface of the cured coating film of the epoxy binder coating material), each antifouling coating material composition of examples or comparative examples shown in Table 1 to Table 3 was applied by using an applicator so that the dry film thickness was 150 μm, dried at 23° C. for 7 days to form an antifouling coating film, and thus test plate 1 with an antifouling coating film was produced.

This test plate 1 with an antifouling coating film was suspended and immersed at a position about 2 m below the sea level off the coast of Hatsukaichi, Hiroshima prefecture, and placed in a stationary condition. 3 months and 12 months after the start of immersion, the area of marine organisms adhered on the antifouling coating film when the total area (test surface) of the antifouling coating film on the constantly submerged part of the test plate was 100% was measured, and the static antifouling property was evaluated based on the following evaluation criteria 1 and/or evaluation criteria 2.

### (Evaluation Criteria 1)

5: area of marine organisms adhered was less than 1% with respect to the test surface.

4: area of the same was 1% or more and less than 10% with respect to the test surface.

3: area of the same was 10% or more and less than 30% with respect to the test surface.

2: area of the same was 30% or more and less than 70% with respect to the test surface.

1: area of the same was 70% or more with respect to the test surface.

### (Evaluation Criteria 2)

3: area of marine organisms adhered was less than 35% with respect to the test surface.

2: area of the same was 35% or more and less than 80% with respect to the test surface.

1: area of the same was 80% or more with respect to the test surface.

### <Coating Film Crack Resistance (Water Resistance) Test>

Test plate 2 with an antifouling coating film was produced in the same manner as test plate 1 with an antifouling coating film for the static antifouling property test, except that sandblasted steel plate (150 mm×70 mm×2.3 mm) was used instead of sandblasted steel plate (300 mm×100 mm×2.3 mm).

Test plate 2 with an antifouling coating film was immersed in artificial seawater at 50° C., and 6 months after the start of immersion, the crack resistance of the coating film was evaluated based on the following evaluation criteria.

### (Evaluation Criteria)

∘: no coating films peeled off and there were no cracks.

Δ: peeling was observed in small portions.

X: peeling was observed in most portions.

TABLE 1

| | | | Example | | | | | | | | |
|---|---|---|---|---|---|---|---|---|---|---|---|
| | | | 1 | 2 | 3 | 4 | 5 | 6 | 7 | 8 | 9 |
| Formulation | (A) | New Coat TS-100 | 28 | 21 | 14 | 10 | 28 | 28 | | | 10.5 |
| (parts by mass) | | PRIMAL TX-100 | | | | | | | 30.4 | | |
| | | Ultrasol N-80 | | | | | | | | 31.1 | |
| | (B) | Harsize NES-500 | 14 | 21 | 28 | 30 | | | | | |
| | | Harsize NES-745 | | | | | 14 | | 14 | 14 | 31.5 |
| | | Hariester SK-370N | | | | | | 14 | | | |
| | (C) | Mica Powder 325mesh | 3 | 3 | 3 | 3 | 3 | 3 | 3 | 3 | 1 |
| | (D) | Cuprous oxide NC-301 | 30 | 30 | 30 | 30 | 30 | 30 | 30 | 30 | 30 |
| | | Zineb TC | 4 | 4 | 4 | 4 | 4 | 4 | 4 | 4 | 4 |
| | | Copper Omadine Powder | | | | | | | | | |
| | | Selektope ® | | | | | | | | | |
| | | TTK Talc | 3.8 | 3.8 | 3.8 | 3.8 | 3.8 | 3.8 | 3.8 | 3.8 | 3.8 |
| | | Noveperm Red F5RK | 0.6 | 0.6 | 0.6 | 0.6 | 0.6 | 0.6 | 0.6 | 0.6 | 0.6 |
| | | Disperbyk-190 | 1.5 | 1.5 | 1.5 | 1.5 | 1.5 | 1.5 | 1.5 | 1.5 | 1.5 |
| | | BYK-018 | 0.3 | 0.3 | 0.3 | 0.3 | 0.3 | 0.3 | 0.3 | 0.3 | 0.3 |
| | | Adekanol UH-752 | 0.5 | 0.5 | 0.5 | 0.5 | 0.5 | 0.5 | 0.5 | 0.5 | 0.5 |
| | | Benton DE | 0.2 | 0.2 | 0.2 | 0.2 | 0.2 | 0.2 | 0.2 | 0.2 | 0.2 |
| | (E) | Ion-exchanged water | 11.6 | 11.6 | 11.6 | 13.6 | 11.6 | 11.6 | 9.2 | 8.5 | 13.6 |
| | | Kyowanol M | 2 | 2 | 2 | 2 | 2 | 2 | 2 | 2 | 2 |
| | | Butyl Cellosolve | 0.5 | 0.5 | 0.5 | 0.5 | 0.5 | 0.5 | 0.5 | 0.5 | 0.5 |

| | | | | | | | | | | |
|---|---|---|---|---|---|---|---|---|---|---|
| | Total | 100 | 100 | 100 | 100 | 100 | 100 | 100 | 100 | 100 |
| Calculated | Solid content (% by mass) | 63.7 | 63.7 | 63.7 | 62.8 | 63.7 | 63.7 | 63.7 | 63.7 | 61.7 |
| value | Content of synthetic resin (A) (parts by mass) | 14.0 | 10.5 | 7.0 | 5.0 | 14.0 | 14.0 | 14.0 | 14.0 | 5.3 |
| | Content of component (B) (parts by mass) | 7.1 | 10.6 | 14.1 | 15.1 | 7.0 | 7.1 | 7.0 | 7.0 | 15.8 |
| | Synthetic resin (A):component (B) (mass ratio) | 1:0.5 | 1:1 | 1:2 | 1:3 | 1:0.5 | 1:0.5 | 1:0.5 | 1:0.5 | 1:3 |
| Result | Static antifouling property test (3 months) evaluation criteria 2 | 3 | 3 | 3 | 3 | 3 | 3 | 3 | 3 | 3 |
| | Static antifouling property test (12 months) evaluation criteria 2 | 3 | 3 | 3 | 3 | 3 | 3 | 3 | 3 | 3 |
| | Crack resistance test (6 months in seawater at 50° C.) | ◯ | ◯ | ◯ | ◯ | ◯ | ◯ | ◯ | ◯ | Δ |

| | | | Example | | | Comparative Example | | | |
|---|---|---|---|---|---|---|---|---|---|
| | | | 10 | 11 | 12 | 1 | 2 | 3 | 4 |
| Formulation | (A) | New Coat TS-100 | 10.5 | 21 | 21 | 10.5 | 6.7 | | 26 |
| (parts by mass) | | PRIMAL TX-100 | | | | | | | |
| | | Ultrasol N-80 | | | | | | | |
| | (B) | Harsize NES-500 | | 21 | 21 | | 33.3 | 40 | |
| | | Harsize NES-745 | 31.5 | | | 31.5 | | | |
| | | Hariester SK-370N | | | | | | | |
| | (C) | Mica Powder 325mesh | 6 | 3 | 3 | | 3 | 3 | 3 |
| | (D) | Cuprous oxide NC-301 | 30 | 30 | 30 | 30 | 30 | 30 | 30 |
| | | Zineb TC | 4 | | | 4 | 4 | 4 | 4 |
| | | Copper Omadine Powder | | 3 | 3 | | | | |
| | | Selektope ® | | | 0.1 | | | | |
| | | TTK Talc | 3.8 | 3.8 | 3.8 | 3.8 | 3.8 | 3.8 | 14.3 |
| | | Noveperm Red F5RK | 0.6 | 0.6 | 0.6 | 0.6 | 0.6 | 0.6 | 0.6 |
| | | Disperbyk-190 | 1.5 | 1.5 | 1.5 | 1.5 | 1.5 | 1.5 | 1.5 |
| | | BYK-018 | 0.3 | 0.3 | 0.3 | 0.3 | 0.3 | 0.3 | 0.3 |
| | | Adekanol UH-752 | 0.5 | 0.5 | 0.5 | 0.5 | 0.5 | 0.5 | 0.5 |
| | | Benton DE | 0.2 | 0.2 | 0.2 | 0.2 | 0.2 | 0.2 | 0.2 |
| | (E) | Ion-exchanged water | 8.6 | 12.6 | 12.6 | 14.6 | 13.6 | 13.6 | 17.1 |
| | | Kyowanol M | 2 | 2 | 2 | 2 | 2 | 2 | 2 |
| | | Butyl Cellosolve | 0.5 | 0.5 | 0.5 | 0.5 | 0.5 | 0.5 | 0.5 |

| | | | | | | | | |
|---|---|---|---|---|---|---|---|---|
| | Total | 100 | 100 | 100.01 | 100 | 100 | 100 | 100 |
| Calculated | Solid content (% by mass) | 66.7 | 62.7 | 62.7 | 60.7 | 62.8 | 62.8 | 66.1 |
| value | Content of synthetic resin (A) (parts by mass) | 5.3 | 10.5 | 10.5 | 5.3 | 3.4 | 0 | 13 |
| | Content of component (B) (parts by mass) | 15.8 | 10.6 | 10.6 | 15.8 | 16.8 | 20.2 | 0.0 |
| | Synthetic resin (A):component (B) (mass ratio) | 1:3 | 1:1 | 1:1 | 1:3 | 1:5 | 0:1 | 1:0 |
| Result | Static antifouling property test (3 months) evaluation criteria 2 | 3 | 3 | 3 | 3 | 3 | Peeling | 3 |
| | Static antifouling property test (12 months) evaluation criteria 2 | 3 | 3 | 3 | 2 | 3 | Peeling | 1 |
| | Crack resistance test (6 months in seawater at 50° C.) | ◯ | ◯ | ◯ | X | X | X | ◯ |

TABLE 2

| | | | Example | | | | | |
|---|---|---|---|---|---|---|---|---|
| | | | 1 | 2 | 3 | 4 | 11 | 12 |
| Formulation | (A) | New Coat TS-100 | 28 | 21 | 14 | 10 | 21 | 21 |
| (parts by mass) | | PRIMAL TX-100 | | | | | | |
| | | Ultrasol N-80 | | | | | | |
| | (B) | Harsize NES-500 | 14 | 21 | 28 | 30 | 21 | 21 |
| | | Harsize NES-745 | | | | | | |
| | | Hariester SK-370N | | | | | | |
| | (C) | Mica Powder 325mesh | 3 | 3 | 3 | 3 | 3 | 3 |
| | (D) | Cuprous oxide NC-301 | 30 | 30 | 30 | 30 | 30 | 30 |
| | | Zineb TC | 4 | 4 | 4 | 4 | | |
| | | Copper Omadine Powder | | | | | 3 | 3 |
| | | Selektope ® | | | | | | 0.1 |
| | | TTK Talc | 3.8 | 3.8 | 3.8 | 3.8 | 3.8 | 3.8 |
| | | Noveperm Red F5RK | 0.6 | 0.6 | 0.6 | 0.6 | 0.6 | 0.6 |
| | | Disperbyk-190 | 1.5 | 1.5 | 1.5 | 1.5 | 1.5 | 1.5 |
| | | BYK-018 | 0.3 | 0.3 | 0.3 | 0.3 | 0.3 | 0.3 |
| | | Adekanol UH-752 | 0.5 | 0.5 | 0.5 | 0.5 | 0.5 | 0.5 |
| | | Benton DE | 0.2 | 0.2 | 0.2 | 0.2 | 0.2 | 0.2 |
| | (E) | Ion-exchanged water | 11.6 | 11.6 | 11.6 | 13.6 | 12.6 | 12.6 |
| | | Kyowanol M | 2 | 2 | 2 | 2 | 2 | 2 |
| | | Butyl Cellosolve | 0.5 | 0.5 | 0.5 | 0.5 | 0.5 | 0.5 |

| | | | | | | | |
|---|---|---|---|---|---|---|---|
| | Total | 100 | 100 | 100 | 100 | 100 | 100.01 |
| Calculated | Solid content (% by mass) | 63.7 | 63.7 | 63.7 | 62.8 | 62.7 | 62.7 |
| value | Content of synthetic resin (A) (parts by mass) | 14.0 | 10.5 | 7.0 | 5.0 | 10.5 | 10.5 |
| | Content of component (B) (parts by mass) | 7.1 | 10.6 | 14.1 | 15.1 | 10.6 | 10.6 |
| | Synthetic resin (A):component (B) (mass ratio) | 1:0.5 | 1:1 | 1:2 | 1:3 | 1:1 | 1:1 |
| Result | Static antifouling property test (3 months) evaluation criteria 1 | 4 | 5 | 5 | 5 | 5 | 5 |
| | Static antifouling property test (12 months) evaluation criteria 1 | 2 | 2 | 2 | 3 | 2 | 4 |

TABLE 3

| | | | Example | | | | Comparative Example | |
|---|---|---|---|---|---|---|---|---|
| | | | 13 | 14 | 15 | 16 | 5 | 6 |
| Formulation | (A) | Emulsion 1 | 20 | 20 | 20 | 20 | 30 | 20 |
| (parts by mass) | (B) | Emulsion 2 | 10 | 10 | 10 | 10 | | 10 |
| | (C) | Mica Powder 325mesh | 5 | | | 10 | | |
| | | Suzolite Mica 200-HK | | 5 | | | | |
| | | Mica powder 100 mesh | | | 5 | | | |
| | (D) | Cuprous oxide NC-301 | 45 | 45 | 45 | 45 | 45 | 45 |
| | | Copper Omadine Powder | 2 | 2 | 2 | 2 | 2 | 2 |
| | | TTK Talc | 2 | 2 | 2 | 2 | 4 | 2 |
| | | MIO-NM | | | | | | 10 |
| | | Tipaque R-930 | 1 | 1 | 1 | 1 | 4 | 1 |
| | | Red iron oxide No. 404 | 1 | 1 | 1 | 1 | 3 | 1 |
| | | Disperbyk-190 | 1 | 1 | 1 | 1 | 1 | 1 |
| | | BYK-018 | 0.1 | 0.1 | 0.1 | 0.1 | 0.1 | 0.1 |
| | | Adekanol UH-752 | 0.5 | 0.5 | 0.5 | 0.5 | 0.5 | 0.5 |
| | (E) | Ion-exchanged water | 10.9 | 10.9 | 10.9 | 10.9 | 9.9 | 10.9 |
| | | Kyowanol M | 1 | 1 | 1 | 1 | 1 | 1 |
| | | Butyl Cellosolve | 0.5 | 0.5 | 0.5 | 0.5 | 0.5 | 0.5 |

| | | | | | | | |
|---|---|---|---|---|---|---|---|
| | Total | 100 | 100 | 100 | 105 | 101 | 105 |
| Calculated | Solid content (% by mass) | 70.6 | 70.6 | 70.6 | 72.0 | 71.4 | 72.0 |
| value | Content of synthetic resin (A) (parts by mass) | 9.0 | 9.0 | 9.0 | 9.0 | 13.5 | 9.0 |
| | Content of component (B) (parts by mass) | 5.0 | 5.0 | 5.0 | 5.0 | 0.0 | 5.0 |
| | Synthetic resin (A):component (B) (mass ratio) | 1:0.6 | 1:0.6 | 1:0.6 | 1:0.6 | 1:0 | 1:0.6 |
| Result | Static antifouling property test (3 months) evaluation criteria 1 | 4 | 5 | 5 | 5 | 5 | 5 |
| | Static antifouling property test (12 months) evaluation criteria 1 | 4 | 4 | 4 | 4 | 4 | 4 |
| | Crack resistance test (6 months in seawater at 50° C.) | Δ | ◯ | ◯ | ◯ | X | X |

The details of the components used in the examples and comparative examples are as follows.

TABLE 4

| Component | | Trade name | Remarks |
|---|---|---|---|
| (A) | Synthetic | New Coat TS-100 | Acrylic acid ester copolymer emulsion, manufactured by Shin-Nakamura |
| | resin | | Chemical Co., Ltd., solid content 50%, Tg: −35° C. |
| | | PRIMAL TX-100 | Acrylic emulsion, manufactured by Dow Inc., solid content 46%, Tg: |
| | | | 28° C. |
| | | Ultrasol N-80 | Acrylic emulsion, manufactured by Aiea Kogyo Co., Ltd., solid content |
| | | | 45%, Tg: 80° C. |
| | | Emulsion 1 | Emulsion of silyl ester copolymer, solid content 45%, Tg: 39.4° C. |
| (B) | Resin acid | Harsize NES-500 | Modified rosin emulsion, manufactured by Harima Chemicals, Inc., solid |
| | and | | content 50.4% |
| | derivative | Harsize NES-745 | Special modified rosin emulsion, manufactured by Harima Chemicals, |
| | thereof | | Inc., solid content 50.3% |
| | | Hariester SK-370N | Rosinized emulsion, manufactured by Harima Chemicals, Inc., solid |
| | | | content 50.5% |
| | | Emulsion 2 | Rosin zinc salt emulsion, solid content 50%, Tg: 57.9° C. |
| (C) | Flaky | Mica Powder 325mesh | Mica, manufactured by Fukuoka Talc Co., Ltd., aspect raio 16.2 |
| | pigment | Suzolite Mica 200-HK | Mica, manufactured by Suzorite Mining Inc., aspect ratio 18.3 |
| | | Mica powder 100 mesh | Mica, manufactured by Fukuoka Talc Co., Ltd., aspect raio 20.5 |
| (D) | Antifouling | Cuprous oxide NC-301 | Cuprous oxide, manufactured by NC Tech Co., Ltd. |
| | agent | Zineb TC | Zinc ethylene bisdithiocarbamate, manufactured by Cerexagri S.A. |
| | | Copper Omadine Powder | Copper pyrithion, manufactured by Arch UK Biocides Ltd. |
| | | Selektope ® | Medetomidine, manufactured by I-TECH AB |
| | Extender | TTK Talc | Talc, manufactured by Takehara Chemical Industry Co., Ltd., |
| | pigment | | aspect ratio 3 |
| | Coloring | MIO-NM | Ferric oxide, manufactured by Nippon Inorganic Colour & Chemical Co., |
| | pigment | | Ltd., aspect ratio 3.2 |
| | | Noveperm Red F5RK | Naphthol red, manufactured by Clariant Japan K.K. |
| | | Tipaque R-930 | Titanium dioxide, manufactured by Ishihara Sangyo Kaisha, Ltd. |
| | | Red iron oxide No.404 | Red iron oxide, manufactured by Morishita Bengara Kogyo Co., Ltd. |
| | Dispersing | Disperbyk-190 | Solution of high molecular weight block copolymer having pigment |
| | agent | | affinity group, manufactured by BYK-Chemie Japan Co., Ltd., solid |
| | | | content 40% |
| | Antifoaming | BYK-018 | Mixture of defoaming polysiloxane and hydrophobic particles, |
| | agent | | manufactured by BYK-Chemie Japan Co., Ltd., solid content 97% |
| | Thickening | Adekanol UH-752 | Polyether polyol urethane polymer, manufactured by ADEKA |
| | agent | | Corporation, solid content 28% |
| | Antisettling | Benton DE | Hectorite clay, 1-hydroxyethylidene-1,1-tetrasodium disulfonate |
| | agent | | mixture, manufactured by Elementis Specialties Inc. |
| | Film-forming | Kyowanol M | 2,2,4-trimethyl-1,3-pentanediol monoisobutyrate, manufactured by KH |
| | agent | | Neochem Co., Ltd. |
| | | Butyl Cellosolve | Ethylene glycol monobutyl ether, manufactured by KH |
| | | | Neochem Co., Ltd. |

What is claimed is:

1. A waterborne antifouling coating material composition, comprising:
synthetic resin (A);
at least one component (B) selected from a resin acid and a derivative thereof;
flaky pigment (C) having an aspect ratio of from 5 to 30;
antifouling agent (D); and
water (E),
wherein a mass ratio (A):(B) between the synthetic resin (A) and the component (B) is 1:0.1 to 1:4.

2. The waterborne antifouling coating material composition according to claim 1, wherein the synthetic resin (A) is at least one selected from a (meth)acrylic resin, a styrene resin, another vinyl resin, an urethane resin, and a hydrolyzable resin.

3. The waterborne antifouling coating material composition according to claim 1, wherein the flaky pigment (C) is mica having an aspect ratio of 5 to 30.

4. The waterborne antifouling coating material composition according to claim 1, wherein the component (B) is at least one selected from rosin and a derivative thereof.

5. The waterborne antifouling coating material composition according to claim 1, wherein the component (B) is a component other than an alkali metal salt.

6. An antifouling coating film formed from the waterborne antifouling coating material composition according to claim 1.

7. A substrate with an antifouling coating film, comprising:
a substrate; and
the antifouling coating film according to claim 6 provided on a surface of the substrate.

8. A method for producing a substrate with an antifouling coating film, the method comprising: (1) applying or impregnating to a substrate the waterborne antifouling coating material composition according to claim 1 to obtain an applied body or an impregnated body; and (2) drying the applied body or the impregnated body.
